(19) United States
(12) Patent Application Publication
(10) Pub. No.: US 2017/0075660 A1
(43) Pub. Date: Mar. 16, 2017

(54) SYSTEM AND METHOD OF WRITING COMPUTER PROGRAMS

(71) Applicant: Qin Zhang, Los Angeles, CA (US)

(72) Inventor: Qin Zhang, Los Angeles, CA (US)

(21) Appl. No.: 15/343,184

(22) Filed: Nov. 3, 2016

Related U.S. Application Data
(63) Continuation-in-part of application No. 62/343,849, filed on Jun. 1, 2016.
Application No. 62/343,849 is a continuation-in-part of application No. 11/409,460, filed on Apr. 22, 2006, now Pat. No. 8,019,714.
Application No. 11/409,460 is a continuation-in-part of application No. 12/317,582, filed on Dec. 24, 2008, now Pat. No. 7,930,319.
Application No. 12/317,582 is a continuation-in-part of application No. 14/817,213, filed on Aug. 4, 2015, now abandoned.
Application No. 14/817,213 is a continuation-in-part of application No. 14/702,763, filed on May 4, 2015.
Application No. 14/702,763 is a continuation-in-part of application No. 15/086,065, filed on Mar. 31, 2016, now abandoned.
Application No. 15/086,065 is a continuation-in-part of application No. 13/763,736, filed on Feb. 11, 2013.
Application No. 13/763,736 is a continuation-in-part of application No. 13/740,270, filed on Jan. 14, 2013.

(51) Int. Cl. G06F 9/44; G06F 17/28

(52) U.S. Cl. CPC G06F 8/31; G06F 17/28

(57) ABSTRACT

The present invention provides a system and method of writing computer programs, by creating and organizing computer programming elements and processes of writing computer programs. Generally, the system and method will help users to writing computer programs without any need of knowing any computer programming languages. The system and method may also be able to write computer programs and executing the programs without any human inputs when certain conditions are met.

### CROSS REFERENCE TO RELATED APPLICATIONS

The present application claims the priority, benefit, and makes reference of and incorporate by reference in full the provisional application entitled “A Thinking System and Method” with Application No. 60/749,808 filed on Dec. 12, 2005, the utility application entitled “Thinking System and Method” with application Ser. No. 11/409,460 filed on Apr. 22, 2006, the provisional application entitled “System and Method for Information Processing and Motor Control” with Application No. 60/958,132 filed on Jul. 2, 2007, the utility application entitled “A System and Method for Information Processing and Motor Control” with application Ser. No. 12/215,108 filed on Jun. 25, 2008, and the provisional application entitled “Search Method and System Using Thinking System” with Application No. 61/010,800 filed on Jan. 10, 2008, and the provisional application entitled “Content Summarizing and Search Method and System” with Application No. 61/194,075 filed on Sep. 24, 2008, the provisional application entitled “Search Methods and Various Applications” with Application No. 61/198,836 filed on Nov. 10, 2008, the non-provisional application entitled “Search Methods and Various Applications” with application Ser. No. 12/590,394, filed on Nov. 6, 2009; the non-provisional application entitled “Search Method and System Using Thinking System” with application Ser. No. 12/317,582 filed on Dec. 24, 2008, and the non-provisional application entitled “Content Summarizing and Search Method and System” with application Ser. No. 12/586,414 filed on Sep. 21, 2009, the non-provisional application entitled “Search Methods and Various Applications” with application Ser. No. 13/763,736 filed on Feb. 11, 2013, and the non-provisional application entitled “Content Summarizing and Search Method and System” with application Ser. No. 13/740,270 filed on Jan. 14, 2013; the non-provisional application entitled “Image Categorization Database and Related Applications”, with application Ser. No. 13/969,609, filed on Aug. 19, 2013; the non-provisional application “A System and Method for Information Processing and Motor Control”, with application Ser. No. 12/452,249, filed on Dec. 18, 2009, which is filed as a national stage application of the International Application PCT/US2008/007873, filed on Jun. 25, 2008; the non-provisional application “A System and Method for Information Processing and Motor Control”, with application Ser. No. 14/018,419, filed on Sep. 5, 2013;

the non-provisional application “System and Method for Web Directory and Search Result Display and Web Page Identifications”, with application Ser. No. 13/447,151, filed on Apr. 13, 2012; the non-provisional application “System and method for web page identifications” with application Ser. No. 12/800,712, filed on May 19, 2010; the non-provisional application “System and method for web directory and search result display” with application Ser. No. 12/384,597, Apr. 7, 2009; the non-provisional application “System and Method for Web Directory and Search Result Display and Web Page Identifications”, with application Ser. No. 14/702,763, filed on May 4, 2015; the non-provisional application “A System and Method for Information Processing and Motor Control”, with application Ser. No. 14/817,213, filed on Aug. 4, 2015;
and the provisional application “SYSTEM AND METHOD OF WRITING COMPUTER PROGRAMS”, with Application No. 62/343,849, filed on Jun. 1, 2016.

### FIELD OF INVENTION

The present invention provides a system and method of writing computer programs, by creating and organizing computer programming elements and processes of writing computer programs. Generally, the system and method will help users to writing computer programs without any need of knowing any computer programming languages. The system and method may also be able to write computer programs and executing the programs without any human inputs when certain conditions are met.

### BACKGROUND OF INVENTION

Although computers are widely used by majority of the population, most people cannot write computer programs. Even for computer programming professionals, writing computer programs is a cumbersome task, and prune for errors.

Although various programming languages are created to simplify the process, it is still impossible to writing computer programs without specific knowledge of computer program languages.

In addition, as various programs are written in various programming languages, there are serious problems of software compatibility.

All these problems significantly limit the capabilities of computers.

### SUMMARY OF INVENTION

The present invention provides a system and method of writing computer programs, by creating and organizing computer programming elements and processes of writing computer programs. Generally, the system and method will help users to writing computer programs without any need of knowing any computer programming languages. The system and method may also be able to write computer programs and executing the programs without any human inputs when certain conditions are met.

A system for writing computer programs, comprising:

One or more memory storage devices with:

A human language knowledge structure including human language element files, and human language element file organizing mechanism;

A computer language knowledge structure including computer language element files, and computer language element file organizing mechanism;

A System Process file structure including system process files, and system process file organizing mechanism;

A program process file structure including program process files, and program process file organizing mechanism;

An executing system;

One or more inputting devices;

One or more outputting devices;

A hardware processor in communication with the memory storage device and configured by the executing system to:

Receive information from inputting devices;

Process inputting information using human language knowledge structure;

Selecting system process file using computer language knowledge structure and processed inputting information;

Writing computer program using system process files and program process files; and

Sending computer program to outputting devices.

A method for writing computer programs, comprising the steps of:

Establishing a human language knowledge structure including human language element files, and human language element file organizing mechanism;

Establishing a computer language knowledge structure including computer language element files, and computer language element file organizing mechanism;

Establishing a system process file structure including system process files, and system process file organizing mechanism;

Establishing a program process file structure including program process files, and program process file organizing mechanism;

Establishing an executing system; for

Processing inputting information using human language knowledge structure;

Selecting system process file using computer language knowledge structure and processed inputting information; and

Writing computer program using system process files and program process files.

### BRIEF DESCRIPTION OF THE DRAWINGS

Embodiments will now be described by way of non-limiting examples with reference to the following figures:

FIG. 1 is a diagrammatic illustration of an exemplary overall method according to an exemplary embodiment;

FIG. 2 shows a schematic of an exemplary computing system 100 according to illustrative embodiments of the present invention;

FIG. 3 shows a schematic of an exemplary software system 200 according to illustrative embodiments of the present invention;

### DEFINITIONS

In the following description, the following definitions are applicable throughout (including above).

A “computer” may refer to one or more apparatus and/or one or more systems that are capable of accepting a structured input, processing the structured input according to predetermined rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a personal digital assistant (PDA); a portable telephone; application-specific hardware to emulate a computer and/or software, such as, for example, a digital signal processor (DSP), a field-programmable gate array (FPGA), a general graphics processor (GPA), a graphics processing unit (GPU), a general purpose processors (GPP), an application specific instruction-set processor (ASIP), an application specific integrated circuit (ASIC), an embedded processor, a chip, chips, a system on a chip, multi-processor system on chip (MPSoC), or a chip set; a data acquisition device; an optical computer; and an apparatus that may accept data, may process data in accordance with one or more stored software programs, may generate results, and typically may include input, output, storage, arithmetic, logic, and control units.

“Software” may refer to predetermined rules to operate a computer. Examples of software may include: software; code segments; instructions; applets; pre-compiled code; interpreted code; compiled code; computer programs; and programmed logic.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash removable memory; a memory chip; and/or other types of media that can store machine-readable instructions thereon.

A “computer system” may refer to a system having one or more computers, where each computer may include a computer-readable medium embodying software to operate the computer. Examples of a computer system may include: a distributed computer system for processing information via computer systems linked by a network; two or more computer systems connected together via a network for transmitting and/or receiving information between the computer systems; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet. Exemplary networks may operate with any of a number of protocols, such as Internet protocol (IP), asynchronous transfer mode (ATM), and/or synchronous optical network (SONET), user datagram protocol (UDP), IEEE 802.x, etc.

### DETAILED DESCRIPTION

Exemplary embodiments are described in detail below. While specific exemplary embodiments are discussed, it should be understood that this is done for illustration purposes only. In describing and illustrating the exemplary embodiments, specific terminology is employed for the sake of clarity. However, the following is not intended to be limited to the specific terminology so selected. A person skilled in the relevant art will recognize that other components and configurations may be used without parting from the spirit and scope of the application. It is to be understood that each specific element includes all technical equivalents that operate in a similar manner to accomplish a similar purpose. The examples and embodiments described herein are non-limiting examples.

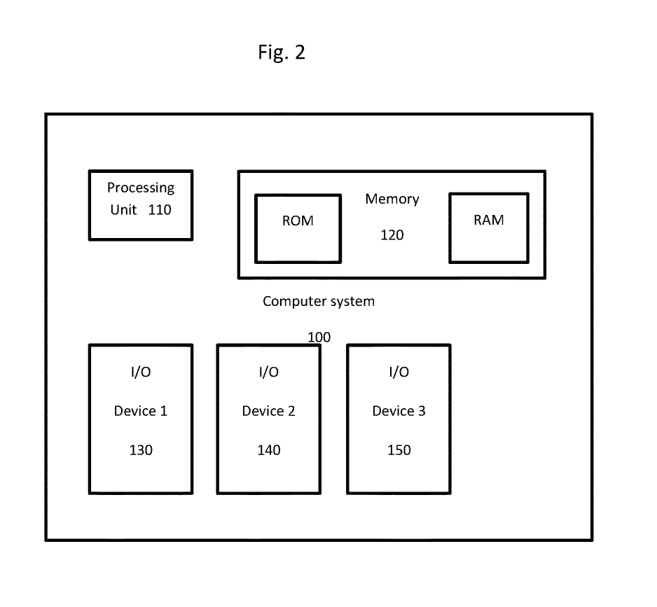

With reference to FIG. 2, an exemplary computer system of the present invention 100 includes a bus, a processor unit 110, a memory 120 including a random access memory (RAM) and a read only memory (ROM), a storage device, a first input/output device 130, an second input/output device 140, and third input/output device 150, and communication interface.

The bus may include one or more interconnects that permit communication among the components of the computer system 100. The processor unit 110 may include any type of processor, microprocessor, multi-core processor, or processing logic that may interpret and execute instructions. The memory 120 may include a random access memory (RAM) or another type of dynamic storage device that may store information and instructions for execution by the processor unit 110. The memory 120 may also be used to store temporary variables or other intermediate information during execution of instructions by the processor unit 110.

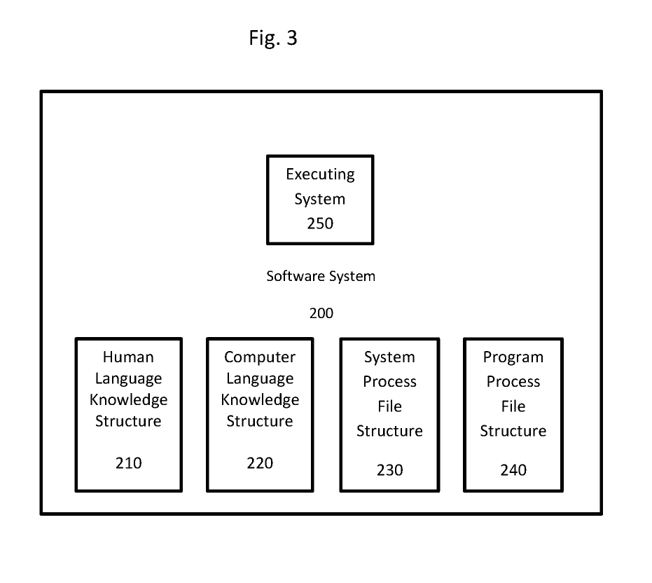

The ROM may include a ROM device and/or another type of static storage device that may store static information and instructions for the processor unit 110. The storage device may include a magnetic disk and/or optical disk and its corresponding drive for storing information and/or instructions. The storage device may include a single storage device or multiple storage devices, such as multiple storage devices operating in parallel. Moreover, the storage device may reside locally in the computer system 100 and/or may be remote with respect to the computer system 100 and connected thereto via a network and/or another type of connection, such as a dedicated link or channel. For example, the storage device may store code for the operating system (OS) of the computer system 100, code for applications running on the operation system including executing system 250 of the software system 200 of the present invention, tools for running the applications, a textual or text-based computing environment, a graphical or graphics-based computing environment, and one or more database to store the various components of software system 200 of the present invention, including a human language knowledge structure 210, a computer language knowledge structure 220, a system process file structure 230, and a program process file structure 240, as shown in FIG. 3.

The first, second and third input/output device 130, 140, 150 may include any mechanism or combination of mechanisms that permit an operator or users to input information to the computer system 100, such as a keyboard, a mouse, accelerometer and gyroscope based input devices, neuro-based interface devices, a touch sensitive display device, a microphone, a pen-based pointing device, and/or a biometric input device, such as a voice recognition device and/or a finger print scanning device. The computer system 100 may receive through the first, second, and third input/output device 130, 140, 150 input data necessary for writing programs.

The first, second and third input/output device 130, 140, 150 may include any mechanism or combination of mechanisms that outputs information to the operator, or users, including a display, a printer, a speaker, etc. The computer system 100 may display on the first, second and third input/output device 130, 140, 150 a user interface screen or window based screens interfaced with the executing system 250, a textual or text-based computing environment screen interfaced with a textual computing environment, and a graphical or graphics-based computing environment screen interfaced with a graphical computing environment. The first, second and third input/output device 130, 140, 150 may include any mechanism or combination of mechanisms that outputs information to memory storage devices, attached to the computer system 100, or detachable from the computer system 100.

### Human Language Knowledge Structure

Human language knowledge structure includes human language element files, and human language element file organizing mechanism. The details of the human language knowledge structure and the operations of the executing system using the human language knowledge structure are disclosed elsewhere (in U.S. Pat. No. 8,019,714, “Thinking system and method”, and related patent applications).

In one embodiment of the present invention, the human language knowledge structure may include a link information field to include computer language elements that are directly corresponding to the human language elements. For example, in the element file for the term “get input in text format”, there could be a link information field include the computer language function get_input(_text).

### Computer Language Knowledge Structure

Computer language knowledge structure includes computer language element files, and computer language element file organizing mechanism. The names of the computer language element files are identical with the name of the elements, and the computer language element file organizing mechanism is a mechanism that can locate the computer language element files based on the names of the computer language element files.

In one preferred embodiment, the computer language element files are provided only for external computer language elements. The external computer language elements are computer language elements that can be called on by the computer operating system, or processes (including functions of the computer languages).

The computer language element files comprise identifying information, and link information. The identifying information can indicate whether the elements are variables, functions, or processes, and what kind of computer language the element belongs to.

In one preferred embodiment, computer language element files may include multiple identifying values, wherein the first identifying values of the computer language element files may indicate the types of computer language system that the elements with these names belong to. The first identifying values of the computer language element files may indicate the version of the computer language that the element is provided with.

The second identifying values of the computer language element files may indicate the general functional categories of the computer languages that the elements with these names belong to. For example, the second identifying values of the computer language element file may indicate an element with the specific name is the name for a variable, a function, a library component, or a processes established by the system and method of the present invention.

The third identifying values of the computer language element files may indicate the data types of variables of the computer languages that the elements with these names belong to. For example, the third identifying value of an element can indicate whether the data provided for the variable should be number, text, etc.

The fourth identifying values of the computer language element files may indicate categorization of variables of the computer languages that the elements with these names belong to. For example, the fourth identifying value of the element can indicate whether it is a class variable, a top class variable, a sub-class variable, or degrees of sub-class variable.

The fifth identifying values of the computer language element files may further indicate other categorizations of variables of the computer languages that the elements with these names belong to. For example, the fifth identifying values of the element may indicate whether it is associated with functions, system process files, program process files, or main system process files, or main program process files, and whether it is the input variable, or result variable of the functions, system process files, or program process files, or main system process files, or main program process files; and whether it is a task specific variable or process specific variable.

The sixth identifying values of the computer language element files may indicate the types of functional significances these elements have. For example, the sixth identifying value of element can indicate whether it is a class function, top class function, sub-class function, or degrees of sub-class function. For example, get_input( ) can be categorized as a top class function, while get_input(_text) can be categorized as a first degree sub-class function.

The seventh identifying values of the computer language element files may further indicate the types of functional significances these elements have. For example, the seventh identifying values of element can indicate whether the function will have outputs, and what kinds of outputs it will produce; and that kinds of inputs it should receive. For example, whether the inputs or outputs should be in the form of text, or number, etc.

The eighth identifying values of the computer language element files may indicate the types of process significances these elements have. For example, the eighth identifying value of the element can indicate whether it is a system process file, a program process file, a main system process file, or a main program process file.

The ninth identifying values of the computer language element files may further indicate the types of process significances these elements have. For example, the ninth identifying value of the element can indicate whether it is for a class process, a top class process, or sub-class process, or degrees of sub-class process. For example, screen_output( ) can be categorized as a top class process, screen_output(get_input( )) can be categorized as a first degree sub-class process, while screen_output(get_input(_text)) can categorized as a second degree sub-class process.

The tenth identifying values of the computer language element files may further indicate the types specific process significances these elements have. For example, the tenth identifying values of element can indicate whether the process will have outputs, and what kinds of outputs it will produce; and what kinds of inputs it should receive. For example, whether the inputs or outputs should be in the form of text, or number, etc. For system process files, the tenth identifying values of the computer language element files may further indicate whether they will require inputs as control constants, because these type of inputs usually should be obtains first, as they might have impacts on the overall structure of the computer programs to be written. The tenth identifying values of the computer language element file may also indicate whether a process is content specific, meaning it can only be called by specific kinds of processes. If a process is not content specific, then it can be called by all kinds of processes.

A function is basically a basic process that is provided by particular computer language. So, the distinction between function and process in the present invention is functions cannot call other functions or processes, but a process generally calls on functions and other processes.

A library component is basically an extended function that is basically a process using the basic functions provided by particular computer language. It can be created by the computer language provider, or a third party provider. So, the distinction between library component and process in the present invention is that a library component is a process provided by others, and a process in the present invention generally is a process created by the system and method of the present invention.

In one embodiment of the system and method of the present invention, the library components can be treated as a function, with the assumption that the system and method of the present invention can incorporate the library components into the process files just as functions, by using the appropriate steps provided by the library providers.

In one embodiment of the system and method of the present invention, the names for computer language element files for functions and library components are the various application forms of the functions and library components. Generally, the names for computer language element files for functions and library components of the system and method of the present invention will incorporate the variables associated with the functions and library components, and if different types of varieties can be used, there will be different names (i.e., different elements with different names).

For example, if there is a function called get_input( ) that will receive input from the keyboard inputs from the users, and the inputs can be a whole number, a segmented number, or text, then the system and method of the present invention may provide different names (and element files) for the function, such as get_input( ), get input(whole_number), get_input(seg_number), get_input(text). By distinguishing different types of variables used by the functions (and library components), different processes can be created for different variations, so that they can each be called with the corresponding variables are being used. When different variables will not require any changes in the process files, the function can be used in its default form (i.e., one name and element file). In this case, it will be get_input( ).

For example, when a process “screen_output” calls for the “get_input” function, if the process in the process file of the “screen_output” will not be changed by input variables, the process file can use the function in its default form, for example, screen_output(get_input( )). If the process in the process file of the “screen_output” will be changed by input variables, then different process files (and different computer language element files for the process files) need to be generated, for example, screen_output(get_input( )), screen_output(input(whole_number)), screen_output(get_input(seg_number)), and screen_output(get_input(text)).

It needs to be noted that the element file for a process file, and process file itself share the same name. But they are accessed by different mechanisms, in the respective database structure.

There are two types of processes referred to in the present invention. One type of process, provided by system process files, is used by the executing system 250 of the system and method of the present invention to write programs. The other type of process, provided by the program process files, is the type that can be used as part of the program to be written. A process may be used for both purpose, but they ought to specifically identified in the computer language element files for the process files, because many process files cannot be used for both purposes. However, in general description, when a process may be used for both purpose, the term “process” or “process file” can be used without specifically making the distinction.

The link information links the computer language element to other computer language elements, and human language elements. For example, the link information can link the element that is a computer language variable to other computer language variables, functions, processes, and human language elements.

The link information links the element that is a function to computer language variables, other functions, processes, and human language elements. For example, the variables associated with the functions, or the types of processes using the functions can be included in the link information. And, other functions that can perform similar task can be linked with this function.

The link information links the element that is a process to computer language variables, functions, other processes, and human language elements. For example, the variables associated with the processes, or the tasks using the processes, or functions used by the processes can be included in the link information.

In one preferred embodiment, computer language element files may include multiple link information fields, wherein the first link information fields of the computer language element files may include the human language elements that the computer language elements are directly corresponding to. For example, if the element file is the element file for function get_input(_text), then the first link information field may include the human language element “get input in text format” as the human language element this function is directly corresponding to.

The second link information fields of the computer language element files may include the class of variables, functions or processes that the elements with the element files belong to. For example, if the element file is the element file for function get_input(_text), then the second link information field may include get_input( ) as the class of functions that this element belongs to.

The third link information fields of the computer language element files may include other variables, functions, or processes that are in the same class categories as the elements with the element files. For example, if the element file is the element file for function get_input(_text), then the third link information field may include get_input(whole_number), and get_input(seg_number) as the functions in the same class category.

The fourth link information fields of the computer language element files may include other variables, functions, or processes that are in the sub-class categories of the elements with the element files. For example, if the element file is the element file for function get_input( ), then the fourth information field may include get_input(whole_number), get_input(seg_number) and get_input(_text) as functions in the sub-class categories of the element.

The fifth link information fields of the computer language element files may include the computer language variables that the elements that are not computer language variables are directly related to. For example, if the element file is the element file for function get_input(_text), then the fifth link information field may include “_text” as the variable for the function get_input(_text). In another example, if the element file is the element file for a system process file calculating_driving_time( ), then the fifth link information field may include a variable driving_time_A_B, and indicating that driving_time_A_B relates to the result of the system process represented in this element file.

The sixth link information fields of the computer language element files may include the computer language functions that the elements that are not computer language functions are directly related to. For example, if the element file is the element file for a process screen_output(get_input(_text)), then the sixth link information field may include get_input(_text) as the function variable for the process.

The seventh link information fields of the computer language element files may include the computer language processes that the elements that are not computer language processes are directly related to. For example, if the element file is the element file for a function get_input(_text), then the seventh link information field may include screen_output(get_input(_text)) as the process that will use function get_input(_text) as variable.

The eighth link information fields of the computer language element files may include other computer language elements that the elements are directly corresponding to. For example, if the element file is the element file for function get_input(_text), then the eighth link information field may include a function element “tget(get_input(_text)” that is functionally identical to get_input(_text) but is a function in different computer language. The eighth link information fields of the computer language element files may include the function element of the computer language in different version than the element with the element files.

In one embodiment of the present invention, ninth link information fields of the computer language element files may include graphic symbol components that the elements can directly call for. For example, if the element file is the element file for a system process file screen_output( ), then the ninth link information field may include the graphic symbol component that can give user options to choose, so the executing system using the system process file can use user's choice to select program process file get_input(whole_number), get_input(seg_number), or get_input(_text).

In one embodiment, a graphic symbol component structure can be established to organize the graphic symbol component files, and the executing system can use the graphic symbol component file organizing mechanism to locate the graphic symbol component files.

In one preferred embodiment, a standardized computer language element structure is established wherein the name of each of the computer language element is directly correspond to one element of particular human language related to the use of the computer language element (and can be corresponding to other elements of the particular human language and other human languages by using information from the particular human language element file).

In one preferred embodiment, each computer language element is given a specific and unique name. For example, variables that can be used as integer or float point variable are divided into different elements, each having its unique name. Functions or processes that can call on various numbers of variables, and/or various kinds of variables are each given a specific and unique name. Functions or processes that can call on none-specific numbers of variables, and/or none-specific variables can be specifically identified.

### System Process File Structure

In one embodiment of the present invention, a system process file structure including system process files, and system process file organizing mechanism.is provided.

The computer language element files for system process files are different from system process files. Computer system process files are files written in one or more computer languages that instruct the executing system to write computer programs. The computer language element files for process files provide information related the process files.

As indicated in the computer language element files for the process files, there are different types of process files. The main goal of the system process files is to instruct the executing system 250 to write various kinds of computer programs when receiving various kinds of inputs.

### Program Process File Structure

In one embodiment of the present invention, a program process file structure including program process files, and program process file organizing mechanism.is provided.

The computer language element files for program process files are different from program process files. Computer program process files are files written in one or more computer languages that can be used by the executing system to write computer programs according to system process files. The computer language element files for program process files provide information related the program process files.

Generally speaking, program process files once selected by the system process files will become parts of the computer program to be written, the executing system 250 may only exchange variables (including computer language variables, computer language function variables, program process file variables with constants or variables according to the system process files.

### Executing System

The executing system is responsible for the general operation of the system and method of the present invention.

In one embodiment of the present invention, the executing system includes means for receiving input information from the user, processing input information using human language knowledge structure; selecting main process files using computer language knowledge structure; using main process files to write computer program, and sending the program to the user or the program for the user.

In one preferred embodiment, the executing system displays the options of tasks and associated variable inputs for users to choose, and use user selections to select computer language main process files using computer language knowledge structure and use the computer language main process files to write the computer programs.

In one preferred embodiment, the executing system displays the options of tasks for users to choose, and use user selection to select computer language main process files based using computer language knowledge structure; the executing system then read the link information in the computer language element file for the main process, and obtain variables, function and process selection needed to use the computer language main process files; the executing system then display the options for the variables, functions or processes, or making inquiries related to the variables, functions or processes; then the executing system will use user input to write the computer programs, or read the link information in the computer language element file for the sub processes, or functions to make further inquiries. The executing system can continue these processes until all the information needed to write the computer programs are obtained. If user inputs are not available for some of the information needed, the executing system can use default value provided in the computer language knowledge structure, in the executing system or in the system process files.

In one preferred embodiment, the executing system makes inquiry regarding task, receiving user input regarding task, analyzing user input using human language knowledge structure to obtain keywords related to tasks, and use the keywords to search computer language process structure to find computer language process files based on operating rules of the computer language process file organizing mechanism;

In one embodiment of the present invention, system process files in the system process file structure are used by the executing system to write computer programs.

For example, various computer programs may require different steps to compile and convert computer programs in particular written language to executable programs. So, there could be different system process files to direct the executing system to write, compile and convert the programming files for different computer languages.

In another embodiment of the present invention, the executing system including a writing module to write computer programs by calling on various program process files using preset rules, logic and commands.

For example, the executing system can have one built-in writing module that incorporate all the process options for programming writing, compiling and converting processes and using control logic to select these options. This embodiment may be suitable when the tasks are not too complex and diversified.

As indicated, there will be different types of processes in writing computer programs using the system and method of the present invention, as there are different types of computer programs. Generally, the executing system selects one framework for particular task either by selecting a system process file and/or by selecting a main program process file for the task.

The system process file includes various steps to write a computer program. For example, for the task of building a website, the steps may include building a main page, and assigning a web address to the main page, and building other pages, assigning web addresses for other pages, and linking other pages to the main page and to each other. For building each page, there could be the steps of generating header graphic, background graphic, and local graphic, and generating header texts, and local texts.

Each step can be further divided into sub-steps, wherein each step can be accomplished by calling on one program process file.

Generally, a system process file is needed for writing a program when the executing system needs to make selections between functions or program process files, or there are logic variables in the process. If no alternative functions or program process files, or logic variables are needed in each step, a main program process file may be used without using a system process file.

An exemplary system process file for creating a website can be called creat_website(create_webpage( ), input_webpage_number), wherein the create_webpage( ) is a sub-system process file for creating web page. The creat_webpage( ) may represent a class of system process files or program process files, wherein the full name of the class can be creat_webpage(input_header_graphic( ), input_back_ground_graphic( ), input_local_graphic( ), input_header_text( ), input_local_text( ), wherein input_header_graphic( ) is a process variable where the user input can be used to select one system process file, or program process file to write program to generate header, wherein input_back_ground_graphic( ) is a process variable where the user input can be used to select a system process file or program process file to write program to generate back ground graphic, wherein input_local_graphic( ) is a process variable where the user input can be used to select a system process file or program process file to write program to generate local graphic, wherein input_header_text( ) is a process variable where the user input can be used to select a system process file or program process file to write program to generate header text, wherein the input_local_text( ) is a process variable where the user input can be used to select a system process file or program process file to write program to generate local text.

There could be more process variables in this example. For example, what should be the fonts for the texts, and where should the texts and graphics be located? These variables could be the process variables for the system process files or program process files, such as input_header_graphic( ), input_back_ground_graphic( ), input_local_graphic( ), input_header_text( ), and input_local_text( ).

For example, the full name of the input_header_graphic( ) could be input_header_graphic(input_graphic_type( ), input_graphic_location( ), input_graphic_size( )); the full name of input_back_ground_graphic could be input_back_ground_graphic(input_graphic_type( ), input_graphic_location( ), input_graphic_size( ), input_display_style( ), input_shade( )). input_graphic_type( ), input_graphic_location( ), input_graphic_size( ), input_display_style( ), input_shade( ) can also have process variables. Notice that input_header_graphic( ) and input_back_ground_graphic( ) could share use of the process files of input_graphic_type( ), input_graphic_location( ), input_graphic_size( ), if they are not process variable.

As illustrated, process files called on in the system process files can either be system process files or program process files, while system process files will allow greater flexibility as they will provide users more options. The options provided by the program process files are limited as they will not allow users to choose alternative functions or processes, and program process files cannot call system process files. It needs to be emphasis again here that program process files if selected will be parts of the programs to be written, while system process files will not be part of the programs to be written, they provide the processes for the executing system to write the programs.

The input_webpage_number in the example should be called a logic variable (although it is a variable in ordinary sense, as it requires an input in numerical number), as it directs the logical process of writing the programs.

In one preferred embodiment of the present invention, the executing system can conduct the information inquiry process through different stages. For example, the executing system can first ask users to input or select the type of tasks to be performed. In the example provided, the task is creating website. Then, the executing system can select the system process file creat_website(create_webpage, input_webpage_number), and require the user to input webpage number, and select the system process file create_webpage(input_header_graphic, input_back_ground_graphic, input_local_graphic, input_header_text, input_local_text) based on the instructions from creat_website(create_webpage, input_webpage_number). Then the executing system will require user to input other information based on system process file of create_webpage, and subsequent system process files and use the input information to write program to create website.

In one embodiment of the present invention, the executing system can provide some default setting after receiving some input from users, and give users the options of selecting other options. For example, after receiving the webpage number information, the executing system can generate website using default settings, and provide display and information input windows and allow user to click on various portion of the default webpages to change the setting.

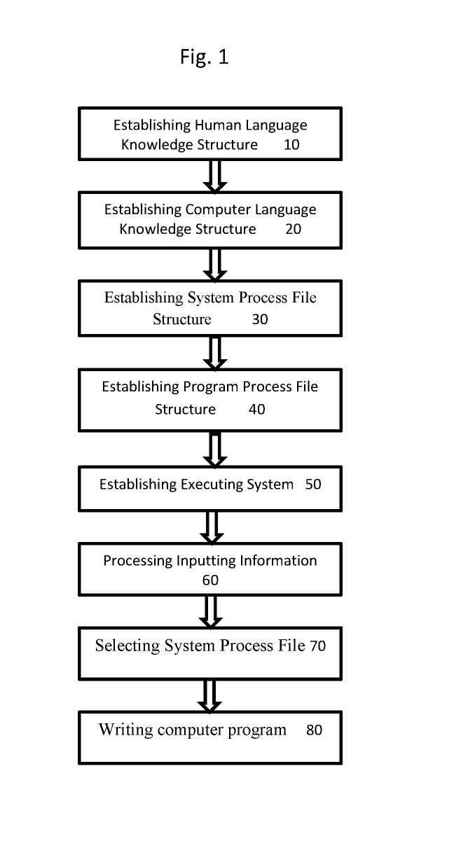

With reference to FIG. 1, the method for writing computer programs of the present invention, comprising the steps of:

Step 10: Establishing a human language knowledge structure including human language element files, and human language element file organizing mechanism;

Step 20: Establishing a computer language knowledge structure including computer language element files, and computer language element file organizing mechanism;

Step 30: Establishing a system process file structure including system process files, and system process file organizing mechanism;

Step 40: Establishing a program process file structure including program process files, and program process file organizing mechanism;

Step 50: Establishing an executing system; for

Step 60: Processing inputting information using human language knowledge structure;

Step 70: Selecting system process file using computer language knowledge structure and processed inputting information; and

Step 80: Writing computer program using system process files and program process files.

With further reference to the executing system 250 in FIG. 3, the executing system 250 is preprogrammed in the system for various tasks and stored in the memory 120 of FIG. 2. The executing system 250 may display a list or palette of associated graphic symbol components in window or generally graphic environment.

In one preferred embodiment, the list presented by the executing system 250 may be divided by categories and subcategories. For example, the list may be divided into web design, database design, internet search, etc., and web design can be further divided into text rich web design, graphic rich web design, static web design, dynamic web design, etc.

The system and method of the present invention can operate in the textual computing environment includes a text-based computing environment such as a computer script language, C code, Python script, Javascript script, hardware description language, and Octave; or at least partially in the graphical computing environment including graphical modeling environments for receiving information from the users and modifying information by the users. The system and method of the present invention can be used to generate programs operating in any kind of environment.

In one preferred embodiment, the system and method of the present invention may include receiving textual or graphic input from the user either in responding to inquiries from the system, or by user's own initiative in the environment of the system and method of the present invention.

In one preferred embodiment, the system and method of the present invention may include language process mechanism in the executing system 250 that can process the textual inputs from the user using information from the human language structure, and select the main system process to start the task based on the inputs.

For example, if the user input is “create website” or “creating website”, the language process mechanism of the present invention will try to search for element files of “create website” or “creating website”, and if there is an element file of “create website” or “creating website”, and a link information field in the element file includes a main system process file (for example, create_website( )) for creating websites, the system can call the main system process file and start the process.

The user inputs can also be used to match with contents of computer language element files, to help user to write the right computer program most suitable for user's needs. For example, if the user is seeking certain results by the help of the computer, the system can use user input to find corresponding element files in the computer language element structure, and if the element file includes identifying information and link information indicating that this input information can be the result of certain process or function, then the system can generate a program using the process or function to obtain the results. The process or function may also require other inputting information from the user, so the system may make specific inquiries to the user, and using the inputs from the user to generate program to obtain the results.

For example, if the user wants to write a program calculating driving time, by inputting “time for driving from Los Angeles to New York?” but the executing system 250 was not able to identify the system process file to complete the task from user inputs, then the executing system 250 may try to use the input to identify computer language variables from the input. If there is a computer language variable “driving_time_A_B” that can be identified from input “time for driving from Los Angeles to New York” by the executing system 250, the executing system 250 can search the computer language element files to find a main system process file that will provide result in the form of computer language variable “driving_time_A_B”. If this main system process file can be found, then the executing system 250 can use the main system process file to start the process. For example, in this case, if the main system process file is called calculate_driving_time( ), and it is a top-level system process file that has sub-class process files calculating_driving_time(driving_time( ), driving_segment, stop_time), calculating_driving_time(driving_time( ), driving_segment), and calculating_driving_time(driving_time( )), then the executing system 250 can present the options to the user, to help user select the right system process file to write the computer program.

As illustrated in this example, the computer language variables that can be the results of certain class of system process files can be linked to only the top-level class system process files, if the executing system 250 can require the users to make selections. This principle could be used in various types of applications where link information between human language elements and computer language elements are provided.

The main system process file generally calls on other processes and functions to complete the task. The processes and functions can be in different computer languages as well. For example, the create_website( ) process can be written mainly in C++ or C# language, and use other languages such as XML, CSS to display the contents of the webpages.

The process of writing computer language program using main system process file can be a dynamic process. This is basically why system process files are needed in addition to the program process files. A dynamic process is a process that user inputs can change the overall structures of the computer programs. A static process is a process where the structures (especially the logic structure) of the computer programs written are basically the same regardless of the user inputs.

For example, in the process of creating website, there could be more than one alternatives. There could be text based websites (users can only define textual contents of the websites) or graphic rich websites (users can define graphics and textual contents of the websites), there could be various pages in the websites, etc. These alternatives can be represented in the process files by process related variables, and logic related variables. For example, there could be an if-then control mechanism in the system process file reflecting the options of text based website, or graphic rich website in the process of creating web site, that can use input from user to make the selection (by basically calling on the system process file corresponding to user's selection). The process could also include an if-then control mechanism to generate various pages of website, by using input as a control constant.

The system process files may also include other control mechanisms such as IF-cascade of ELSE IF-END IF, SWITCH condition—cascade of CASE, DO-WHILE loop, REPEAT-UNTIL loop, IF-nested IF condition-nested IF condition-END IF-END IF, FOR loop, SIMPLE STATE MACHINE, IF-THEN-ELSE-IF, IF-THEN-IF, IF-THEN, IF-THEN-ELSE, IF, cascade of IF-THEN, FOR-WHILE, FOR-loop, WHILE-loop, case, combination of logical signals, vector signals, conditions, conditions with subconditions, conditions which are visually separated, UNLESS conditions, and use user inputs as constants or variables for these logical conditions.

In one embodiment, the inputs from the users can be received and processed in a complete graphical computing environment. In one preferred embodiment of the present invention, the positions in the touch screen in the selected computing environment are received and processed to be used to select system process files and/or write programs and/or producing programming output. In one embodiment, the inputs can be used to modify previous graphic outputs.

The present invention may provide communication interface includes any transceiver like mechanism that enables the computer system 100 to communicate with other devices and/or systems, such as client computers. For example, the communication interface may include one or more interfaces. Alternatively, the communication interface may include other mechanisms for communicating via a network, such as a wireless network. In one implementation, the communication interface may include logic to send code to a destination device, such as a target device that can include general purpose hardware (e.g., a personal computer form factor), dedicated hardware (e.g., a digital signal processing (DSP) device or a field programmable gate array (FPGA) adapted to execute a compiled version of a model or a part of a model), etc.

The computer system 100 may perform certain functions in response to the processor unit 110 executing software instructions included in the computer-readable medium, such as memory 120. A computer-readable medium may be defined as one or more memory devices. In alternative embodiments, hardwired circuitry may be used in place of or in combination with software instructions to implement features consistent with principles of the exemplary embodiments. Thus, implementations consistent with principles of the application are not limited to any specific combination of hardware circuitry and software.

No element, act, or instruction used in the description of the exemplary embodiments should be construed as critical or essential to the exemplary embodiments unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

While various embodiments have been described above, it should be understood that they have been presented by way of example only, and not limitation. Thus, the breadth and scope of the described should not be limited by any of the above-described exemplary embodiments, but should instead be defined only in accordance with the following claims and their equivalents.

What is claimed is:

1. A method for operating a human-made system, comprising the steps of:
Establishing a human language knowledge structure including human language element files, and human language element file organizing mechanism;
Establishing a computer language knowledge structure including computer language element files, and computer language element file organizing mechanism;
Establishing a system process file structure including system process files, and system process file organizing mechanism;
Establishing a program process file structure including program process files, and program process file organizing mechanism;
Establishing an executing system; for
Processing inputting information using human language knowledge structure;
Selecting system process file using computer language knowledge structure and processed inputting information; and
Writing computer program using system process files and program process files.

2. A system for writing computer programs, comprising:
One or more memory storage devices with:
A human language knowledge structure including human language element files, and human language element file organizing mechanism;
A computer language knowledge structure including computer language element files, and computer language element file organizing mechanism;
A System Process file structure including system process files, and system process file organizing mechanism;
A program process file structure including program process files, and program process file organizing mechanism;
An executing system;
One or more inputting devices;
One or more outputting devices;
A hardware processor in communication with the memory storage device and configured by the executing system to:
Receive information from inputting devices;
Process inputting information using human language knowledge structure;
Selecting system process file using computer language knowledge structure and processed inputting information;
Writing computer program using system process files and program process files; and
Sending computer program to outputting devices.

3. A system for writing computer programs, comprising:
One or more memory storage devices with:
A computer language knowledge structure including computer language element files, and computer language element file organizing mechanism;
A System Process file structure including system process files, and system process file organizing mechanism;
A program process file structure including program process files, and program process file organizing mechanism;
An executing system;
A hardware processor in communication with the memory storage device and configured by the executing system to:
Selecting system process file using computer language knowledge structure and processed inputting information;
Writing computer program using system process files and program process files.
